(19) United States
(12) Patent Application Publication
(10) Pub. No.: US 2024/0390787 A1
(43) Pub. Date: Nov. 28, 2024

(54) Systems and Methods for 3D-Model-Based Game Streaming

(71) Applicant: Six Impossible Things Before Breakfast Limited, Dublin (IE)

(72) Inventor: Sherry IGNATCHENKO, Weisling (AT)

(73) Assignee: Six Impossible Things Before Breakfast Limited, Dublin (IE)

(21) Appl. No.: 18/670,105

(22) Filed: May 21, 2024

Related U.S. Application Data
(60) Provisional application No. 63/503,691, filed on May 22, 2023.

(51) Int. Cl. A63F 13/358; A63F 13/52; A63F 13/57; A63F 13/77

(52) U.S. Cl. CPC A63F 13/358; A63F 13/52; A63F 13/57; A63F 13/77

(57) ABSTRACT

A system for implementing three-dimensional model-based game streaming and corresponding methods of use are described herein. The system may include a universal game client configured to run on a client computer system or device that is capable of running various types of three-dimensional games. The universal game client may be configured to receive game state data published by a game server and render a virtual scene for an online game based on the game state data, one or more game assets downloaded over the Internet (e.g., as part of an initial game download or on-demand), and/or predicted information or simulations run by the universal game client. In some implementations, the universal game client may be configured to translate representations of game state data (e.g., from 2D-representations to 3D-representations) as needed for rendering. In some implementations, the universal game client may be embedded as a part of a web browser.

### RELATED APPLICATIONS

This application claims priority to U.S. Provisional Application No. 63/503,691, entitled “Method for 3D-Model-Based Game Streaming,” filed on May 22, 2023, the content of which is hereby incorporated herein by reference in its entirety.

### FIELD OF THE DISCLOSURE

The systems and methods described herein relate to improved techniques for three-dimensional model-based game streaming.

### BACKGROUND

In the online gaming industry, there have been several approaches suggested to implement game streaming. Most of these approaches render game assets at a server, and then pass the rendered game asset data to a game client as a video stream. These approaches often require an extremely stable network connection, consume significant network traffic, require very significant server resources (as the server needs both to render the whole scene for each player, and encode it to high-quality video for each player in real-time), and tend to suffer from very significant “input lag,” which may be understood as a delay between player making an input such as pressing a key and seeing a reaction to the input on their screen. Approaches in which game assets are rendered at the game client similarly suffer from a number of drawbacks. Game assets may include different three-dimensional objects such as characters, items, cars, furniture, buildings, or other structures. Conventionally, game assets for three-dimensional online games were incorporated into games themselves and downloaded when players decide to purchase games. As the complexity of online games has increased, the size of game assets and, correspondingly, download times have increased, which means large waiting times before a player can start playing the game. In addition, existing game clients tend to be game-specific, so a separate game client needs to be downloaded for each of the games This also means that each game developer needs to produce their game client for all the platforms they are going to support. These issues are absent in video-stream based game streaming, but as mentioned above, video-stream based game streaming has its own very significant drawbacks.

In light of the foregoing, there is a continuously evolving need for improved systems and techniques for implementing game streaming in which, on the one hand, do not require excessive server and network resources and do not exhibit excessive input lag, and, on the other hand, allow players to start playing very quickly and do not require separate game clients to be produced for each game for each target platform. Any such techniques for online game streaming would represent an improvement over existing systems.

### SUMMARY OF THE DISCLOSURE

This disclosure relates to a system for implementing three-dimensional (3D) model-based game streaming and corresponding methods of use. In various implementations, the system may include a client computer system or device having one or more processors configured to run a “universal game client” capable of running various types of three-dimensional games. This universal game client may need to be different for each of the target platforms, but it is “universal” in the sense that it may be able to play a vast selection of games on the same platform. The universal game client may be configured to receive game state data published by a game server and render a virtual scene for an online game based on the game state data. In various implementations, the game server may be configured to simulate the online game and publish the game state data based on the simulation of the online game at the game server. The universal game client and one or more game assets associated with any game to be rendered by the universal game client may be provided for download over the Internet. For example, in addition to three-dimensional meshes or models, textures, normal maps, and/or other information needed to render an online game, game assets for a game may include client-side descriptors that each provide information related to the online game and/or other assets providing information related to an online game. For example, the assets may include one or more velocity profiles associated with three-dimensional objects to be rendered within the game. In some implementations, one or more of the game assets may be downloaded as part of an initial game download for the online game. In some implementations, one or more game assets may be downloaded as needed by the universal game client (i.e., on-demand or upon request). The universal game client may be configured to render a virtual scene within an online game based on both the game state data published by the game server and the one or more game assets downloaded over the Internet.

According to at least one aspect of the invention, the universal game client may be configured to predict or calculate information or run simulations in order to render three-dimensional objects within a virtual scene. For example, game state data received from a game server may include coordinate data and velocity data for at least one object at a given time, and the universal game client may be configured to render the object within the virtual scene based on the game state data. In some implementations, the universal game client may calculate coordinates and a velocity for the object at subsequent times based on the coordinate data and velocity data for an earlier time included in the game state data and render the object based the calculated coordinates and velocity. For example, without receiving updated game state data from the game server, the universal game client may be configured to use the coordinate data and velocity data for an object at one time and a velocity profile for the object to determine coordinates and a velocity of the object at a later time. If updated game state data is received, the universal game client may update the rendering of the object based on the updated game state data. In various implementations, the universal game client may be configured to run physics simulations related to various object and render the objects based on an outcome of the physics simulation. In some implementations, the physics simulation may be run only to determine visual effects (i.e., without affecting gameplay or passing any information regarding an outcome of the simulation back to the game server). In some implementations, the universal game client may be configured to utilize partial simulation results obtained from the game server. In some implementations, the universal game client may be configured to utilize inverse kinematics to render movement of an object within a virtual scene for an online game.

According to another aspect of the invention, the universal game client may include one or more server proxies configured to receive a “subscription” published by the game server comprising the game state data and generate a subscription or game state data to be used by the universal game client to render the virtual scene. For example, the server proxy may be configured to predict movement of an object and/or run simulations and update the game state data accordingly. In some implementations, the server proxy may be configured to predict movement of an object and/or run simulations based on the game state data received from the game server and player input received by the universal game client. In some implementations, the subscription published by the game server may include two-dimensional (2D) or one-dimensional (1D) representations of the game state data. In such implementations, the universal game client may be configured to translate the 2D- or 1D-representations of the game state data into three-dimensional (3D) representations of the game state data to be used for rendering. For example, a graph of 2D polygons included within client-side assets may be used to translate 2D-representations of game state data into three-dimensional (3D) representations of the same game state data. In some implementations, the universal game client may be embedded as a part of a web browser.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example of a system configured to render computer-generated three-dimensional objects at a client computer system based on game state data provided by a game server, according to one or more aspects described herein;

FIG. 2 depicts a block diagram of an example universal game client capable of running various types of three-dimensional games, according to one or more aspects described herein; and

FIG. 3 depicts a block diagram of an example game streaming architecture, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

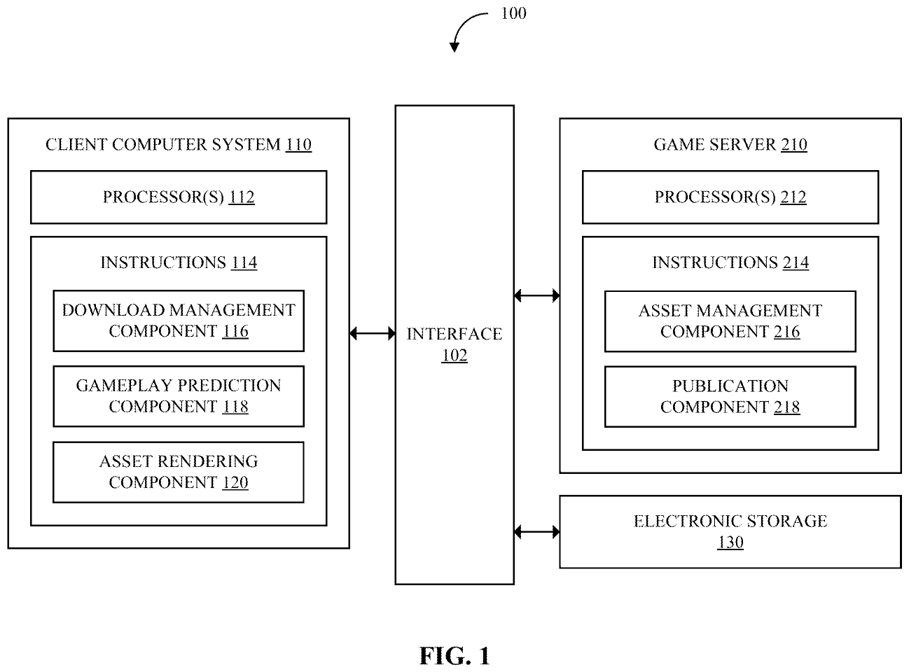

FIG. 1 depicts a block diagram of an example of a system 100 configured to render computer-generated three-dimensional objects at a client computer system 110 based on game state data provided by a game server 210, according to one or more aspects described herein. In various implementations, system 100 may include one or more of an interface 102, at least one client computer system 110, electronic storage 130, a game server 210, and/or other components. In various implementations, client computer system (or device) 110 may comprise a game client computing system (or device). In some implementations, client computer system 110 may be configured to receive instructions and game state data related to an online game comprising three-dimensional virtual scenes from game server 210. Notably, while “three-dimensional objects” and “three-dimensional virtual scenes” are referred to herein, the techniques described herein may apply equally to “two-dimensional objects” and “two-dimensional virtual scenes.” As such, all references herein to “three-dimensional objects” and “three-dimensional virtual scenes” may be replaced with “two-dimensional objects” and “two-dimensional virtual scenes,” respectively. In various implementations, client computer system 110 may include one or more physical processors 112 (also interchangeably referred to herein as processor(s) 112, processor 112, or processors 112 for convenience), computer readable instructions 114, and/or one or more other components. In various implementations, game server 210 may include one or more physical processors 212 (also interchangeably referred to herein as processor(s) 212, processor 212, or processors 212 for convenience), computer readable instructions 214, and/or one or more other components. In some implementations, system 100 may include one or more external resources, such as sources of information outside of system 100, external entities participating with system 100, and/or other resources. In various implementations, system 100 may be configured to receive input from or otherwise interact with one or more users via client computer system 110 and/or game server 210.

In various implementations, processor(s) 112, 212 may be configured to provide information processing capabilities in system 100. As such, the processor(s) 112, 212 may comprise one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. Processor(s) 112, 212 may be configured to execute one or more computer readable instructions 114, 214. Computer readable instructions 114, 214 may include one or more computer program components. In various implementations, computer readable instructions 114 may include one or more of update management component 116, gameplay prediction component 118, asset rendering component 120, and/or one or more other computer program components, and computer readable instructions 214 may include one or more of asset management component 216, publication component 218, and/or other computer program components. As used herein, for convenience, the various computer readable instructions 114, 214 will be described as performing an operation, when, in fact, the various instructions program the processor(s) 112, 212 (and therefore client computer system 110 or game server 210) to perform the operation.

In various implementations, client computer systems 110 may subscribe to receive game updates from a game server 210 related to an online game. For example, game server 210 may “publish” game state, and one or more of client computer system 110 may “subscribe” to receive the published game state. As a result of such a “subscription” by a client computer system 110, game server 210 may (a) send client computer system 110 a current game state, (b) include client computer system 110 (identified, for example, by its IP address and/or network socket which is used to communicate with client computer system 110) on a list of “subscribers” for this “publication”, and (c) whenever published game state is updated (for example, as a result of user inputs sent to the game server and/or as a result of simulation), game server 210 may send the update to the game state to all the current “subscribers”. In response to the updated game state data and/or as otherwise necessary, client computing system 110 may be configured to download game assets from game server 210 for rendering within virtual scenes of the game. To that end, in various implementations, asset management component 216 may be configured to generate, organize, encode, and/or otherwise manage game assets used to render a virtual scene. For example, game assets may comprise the three-dimensional objects that, when rendered, make up a virtual scene in a game.

In various implementations, publication component 218 may be configured to publish data regarding a current state of the game. In various implementations, publication component 218 may be configured to use mechanisms such as Unity sync variables, UE4 variable replication, or ZeroMQ or global-mq publications. In various implementations, a publication may include a current level, list of items and/or non-player characters (NPCs) with identifiers for their three-dimensional models and/or their coordinates. In some implementations, a publication may be compressed using compression methods for structured data. For example, a given publication may be compressed using one or more techniques described in U.S. patent application Ser. No. 18/438,702, entitled “SYSTEMS AND METHODS FOR IMPROVING COMPRESSION OF STRUCTURED DATA IN THREE-DIMENSIONAL APPLICATIONS,” filed Feb. 12, 2024, the content of which is hereby incorporated by reference herein in its entirety.

In various implementations, publication component 218 may be configured to use UDP as a transport protocol to synchronize “subscription” on the client-side (i.e., at client computer systems 110) with a “publication” on the server-side (i.e., at game server 210). In some implementations, publication component 218 may be configured to send updated game state data (or “updates”) as “publication” within UDP packets. In such implementations, publication component 218 may be configured to send updated game state data within UDP packets at regular intervals. The moments of such updates (i.e., at regular intervals) may be referred to as a “network ticks.” Typically, movements are simulated within an online game at the same time that an update is published. The moments when movements are simulated within an online game may be referred to as “simulation ticks.” Thus, typically, “simulation ticks” occur at the same time as “network ticks.” In some implementations, however, simulation ticks may occur at a different frequency than network ticks. For example, there may be several simulation ticks per network tick. In some implementations, TCP may be used as a transport protocol. In such implementations, instead of UDP packets, game server 210 may put “messages” into a TCP stream (and client computer system 110 may read them from the TCP stream). In one non-limiting example, each “message” may consist of its length in bytes, plus payload.

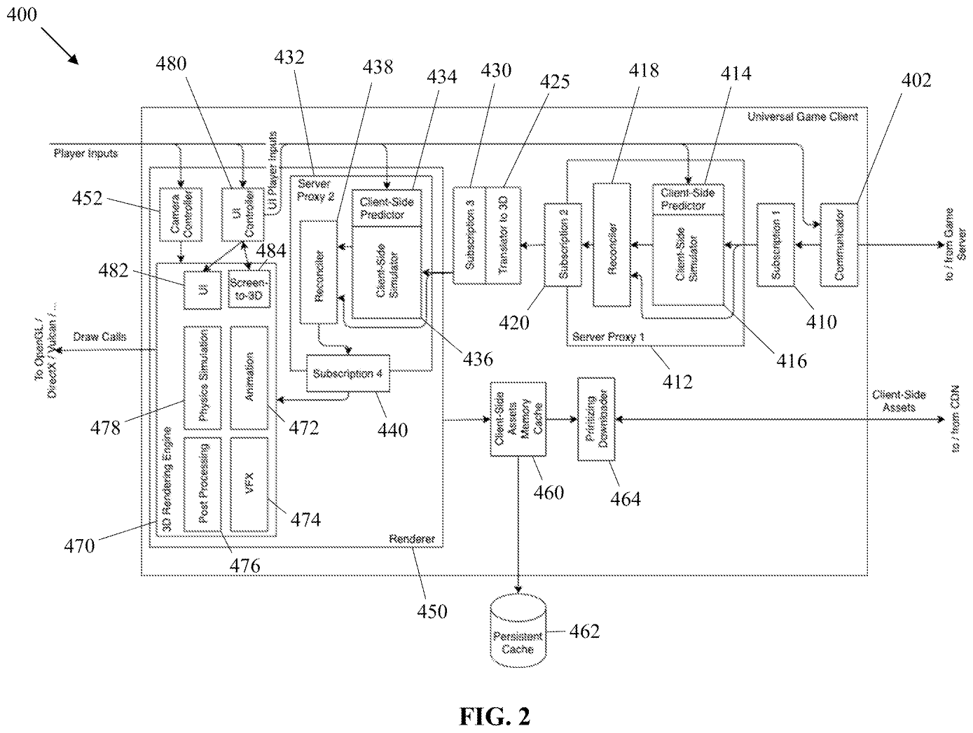

In various implementations, update management component 116 may be configured to manage updates and other information received by client computer system 110 from game server 210. In various implementations, gameplay prediction component 118 may be configured to predict (or calculate) information (such as the coordinates or velocity) of an object based on information received from game server 210. In various implementations, asset rendering component 120 may be configured to render game assets within a virtual scene. In some implementations, some or all of the functionality of update management component 116, gameplay prediction component 118, asset rendering component 120 may be implemented by or otherwise described with respect to universal game client 400 depicted in FIG. 2 and described further herein. In various implementations, one or more processors 112 of client computer system 110 may be configured to download and run universal game client 400.

FIG. 2 depicts a block diagram of an example universal game client 400 capable of running various types of three-dimensional games, according to one or more aspects described herein. In various implementations, game client 400 may include a communicator 402, a server proxy 412, a translator 425, a renderer 450, and/or other game client modules or components described herein. In various implementations, universal game client 400 may be configured to run any game. In various implementations, universal game client 400 may be configured to be completely data-driven. In other words, universal game client 400 may not need to download any code (i.e., only data) to run any supported game. This enables universal game client 400 to get around any “no interpreted code” restrictions which may be present on some platforms (e.g., such as on the Apple App Store).

In various implementations, communicator 402 may be responsible for over-the-network communication. For example, communicator 402 may be configured to use protocols including UDP, TCP, IPX/SPX, and/or similar techniques to facilitate over-the-network communication. In some embodiments, communicator 402 may be configured to facilitate communication using one or more techniques described in U.S. patent application Ser. No. 18/630,409, entitled “SYSTEMS AND METHODS FOR INCREMENTAL DYNAMIC LOADING OF GAME ASSETS,” filed Apr. 9, 2024, U.S. patent application Ser. No. 18/669,729, entitled “SYSTEMS AND METHODS FOR TICK-LESS UDP GAME TRAFFIC,” filed May 21, 2024, and U.S. patent application Ser. No. 18/670,011, entitled “SYSTEMS AND METHODS FOR MOD-SUPPORTING AUTHORITATIVE GAME SERVER,” filed May 21, 2024, the content of each of which is hereby incorporated by reference herein in its entirety.

In various implementations, and as described herein, universal game client 400 may be configured to subscribe to data which may describe a current state of an online game, as also described in U.S. patent application Ser. No. 18/630,409. In various implementations, data related to a game may include or relate to 3D objects, identifiers (or “IDs”) which can be used to retrieve assets associated with 3D objects (e.g., such as meshes, textures, and/or other game assets), the coordinates of a 3D object, and/or other information. In some implementations, a game state (and updates to it) may be compressed using one or more techniques described in U.S. patent application Ser. No. 18/438,702.

In various implementations, universal game client 400 may include a client-side descriptor (which may be included, for example, as a part of the client-side assets) configured to describe an exact structure of published data. In various implementations, universal game client 400 may also be configured to “subscribe” to receive a current object velocity and an ID of the animation that an object (e.g., such as a non-player character (NPC), an in-game item, and/or another object) is using. With this information about a 3D object (e.g., current coordinates, current velocity, and current animation) and indication (or identification) of related assets (which may be downloaded as described, for example, in U.S. patent application Ser. No. 18/630,409), universal game client 400 may be configured to render 3D objects without any other knowledge. In particular, universal game client 400 may be configured to render a 3D object without any knowledge of why the 3D object is moving in a prescribed manner.

In various implementations, universal game client 400 may use one or more techniques described in U.S. patent application Ser. No. 18/669,729, (such as TObj-based publications, Dead Reckoning, and/or “reconciliation”) to publish and/or transmit and/or to calculate coordinates and velocities. In various implementations, information described as embedded in U.S. patent application Ser. No. 18/669,729 (e.g., such as velocity profiles) may be included as part of an initial game download and/or downloaded on-demand (or upon request), as described further herein. For example, one or more velocity profiles for a game object may be included within client-side game assets that are embedded within universal game client 400 (or client computer system 110) and were either included as part of an initial game download or downloaded on-demand (or upon request),

In various implementations, universal game client 400 may be configured to receive subscription 410 from a game server 210 via communicator 402. In various implementations, subscription 410 may comprise an instance of the “subscription.” In various implementations, subscription 410 may represent an exact copy of the game data as it is “published” by game server 210 (albeit with a delay in time).

In various implementations, a first server proxy (“server proxy 412”) may include a client-side predictor 414, a client-side simulator 414, and a reconciler 418 to generate a subscription 420. In various implementations, server proxy 412 may be configured to take updates provided via subscription 410, process them, and present another copy of the same data (i.e., as subscription 420). In doing so, server proxy 412 may be configured to generate a subscription (i.e., subscription 420) with data represented by “smoother” updates to account for packet loss and/or “jitter,” which may result from packets not arriving uniformly distributed in time from game server 210. In various implementations, server proxy 412 may be configured to help address issues stemming from jitter by providing updates that are smoother in time, for example, using techniques described in U.S. patent application Ser. No. 18/669,729. For example, in some implementations, server proxy 412 may be configured to use published coordinates and velocities as of moment TObj with moment TObj to calculate coordinates and/or velocities at any moment T>=TObj.

In various implementations, server proxy 412 may be configured to use client-side extrapolation (a.k.a. Dead Reckoning) to extrapolate the movement of objects (particularly if a packet is lost) and/or reconciliation to sort out differences in calculations between universal game client 400 and game server 210. In some implementations, server proxy 412 may be configured to use client-side extrapolation and/or reconciliation similar to such techniques as described further in U.S. patent application Ser. No. 18/669,729 and/or in “Fast-Paced Multiplayer (Part III): Entity Interpolation” by Gabriel Gambetta, available at https://www.gabrielgambetta.com/entity-interpolation.html (last visited May 13, 2024), the content of which is hereby incorporated by reference herein in its entirety.

In various implementations, server proxy 412 may include a client-side predictor 414 used to show a player the reaction to their own action “immediately.” For example, showing a player the reason to their own action “immediately” may comprise showing a player the reason to their own action without waiting for a client-server-client round-trip, as described, for example, in “Development and Deployment of Multiplayer Online Games, Vol. I: GDD, Authoritative Servers, Communications (Development and Deployment of Multiplayer Games)” by “No Bugs” Hare, translated by Sergey Ignatchenko, and published Jul. 1, 2017, and/or in “Fast-Paced Multiplayer (Part II): Client-Side Prediction and Server Reconciliation” by Gabriel Gambetta, available at https://www.gabrielgambetta.com/client-side-prediction-server-reconciliation.html (last visited May 20, 2024), the contents of each of which are hereby incorporated by reference herein in their entirety. As depicted in FIG. 2, client-side predictor 414 may be configured to receive player inputs and change subscription 420. For example, universal game client 400 may include another client-side descriptor (which may be included, for example, as a part of the client-side assets) configured to indicate that whenever a player presses a “forward” button, a player character (PC) immediately starts moving in a direction where they are currently looking according to a “velocity profile” (e.g., as described in U.S. patent application Ser. No. 18/669,729) and/or start a specific animation. In some implementations, client-side predictor 414 may be configured to send a client-side prediction to reconciler 418. In some implementations, to implement client-side prediction, client-side simulator 416 may be configured to generate a simulation of movements, such as player character (PC) movements.

In various implementations, server proxy 412 may be configured to use another client-side descriptor (which may be included, for example, as a part of the client-side assets) to describe the format of the data used in a current game for publishing. In some implementations, the description of the format may include fields, acceptable values, encodings, frequency tables, and/or other related derivatives as described in U.S. patent application Ser. No. 18/438,702.

In various implementations, universal game client 400 may include a 3D translator 425 for situations when game data published by a game server uses 2D-based or 1D-based representations. In some implementations, 3D translator 425 may be configured to use techniques described in U.S. patent application Ser. No. 18/670,011, such as graph-of-polygons or a 1D-based graph. In such implementations, 3D translator 425 may be configured to use information (regarding correspondence between 2D-based and 3D representations or between 1D-based and 3D representations), which may be included in client-side assets, to perform conversion from a 2D-based (or 1D-based) representation into a 3D representation. In various implementations, 3D translator 425 may be configured to present data as yet another subscription (i.e., subscription 430). In such implementations, subscription 430 may use a 3D representation of the game data even if game server publishes a 2D-based or 1D-based representation (and therefore subscription 410 may be 2D- or 1D-based). In various implementations, 3D translator 425 may use another client-side descriptor (which may be included, for example, as a part of the client-side assets) to indicate how 2D-based or 1D-based translation has to be performed for a particular game. For example, when a particular game is a 2D game, 3D translator 425 may be configured to translate into 2D representation instead of 3D. In such implementations, even if subscription 420 is using a 2D-based representation (such as graph of 2D polygons), translation into 2D representation (which may not use any graph, but rather be coordinates within a simple 2D) using client-side assets may still be necessary.

In various implementations, renderer 450 may be configured to render a 3D representation of the game data as provided (or included within) subscription 430. In various implementations, renderer 450 may include a second server proxy (“server proxy 432”), a camera controller 452, a three-dimensional (3D) rendering engine 470, and/or one or more other components. In various implementations, server proxy 432 may include a client-side predictor 434, a client-side simulator 436, and a reconciler 438 to generate subscription 440 (similar to server proxy 412). In various implementations, each of the components of server proxy 432 may be configured to perform the same functions as like components described herein with respect to server proxy 412. In various implementations, server proxy 432 may operate over 3D representations of game data, whereas server proxy 412 may operate over 3D, 2D-based, or 1D-based representations of game data. In some implementations, one or more parts of server proxy 432 (or the entirety of server proxy 432) may be implemented as a part of 3D rendering engine 470. In some implementations, universal game client 400 may include only one server proxy (e.g., either server proxy 412 or server proxy 432). In some implementations, the functionality of the server proxies may be split into server proxy 412 and server proxy 432. In other implementations, some functionality such as client-side prediction and/or reconciliation may be implemented both in server proxy 412 and server proxy 432 and/or entirely in one of server proxy 412 and server proxy 432.

In some implementations, in response to player input, client-side predictor 434 may be configured to start some animation (e.g., as specified by client-side descriptor) and send a message with the player input simultaneously to the server-side. This technique may be used to “conceal” some part of (or all) of the client-server-client round-trip from the player. As such, a visible or “perceived” delay between an end of the animation and a next action which comes in response to an update from the game server (received as part of the “subscription”) may become smaller due to a length of the animation. In some implementations, a similar effect may be achieved by client-side predictor 414 changing subscription 420 such that renderer 450 may start the same animation.

In various implementations, renderer 450 may be configured to issue requests for client-side assets. As used herein, client-side assets may be referred to interchangeably as “client-side assets,” “client-side game assets,” or simply “assets.” In some implementations, one or more assets may be requested as soon as a specific game is known (i.e., as part of an “initial game download”), whereas other assets may be requested “on demand.” For example, one or more game assets may be requested and downloaded on demand as described in U.S. patent application Ser. No. 18/630,409. Requests for assets may go to the client-side assets memory cache 460 (which may in turn further cache the client-side assets in persistent cache 462). If neither cache contains the requested assets, a request for the respective asset may be issued to the prioritizing downloader 464, which may be configured to retrieve the requested asset from the Internet, for example, using Content Delivery Network (CDN). In various implementations, the one or more assets (e.g., client-side game assets”) may include some or all of the information described herein as embedded within universal game client 400.

In various implementations, renderer 450 may be configured to use one or more techniques for loading and caching game assets described in U.S. patent application Ser. No. 18/630,409. In various implementations, information or assets described as embedded into the game client (e.g., client computer system 110) in U.S. patent application Ser. No. 18/630,409 may be included as part of an initial game download, as described further herein. These may include, for example, “generic assets,” “frequency tables” as described in U.S. patent application Ser. No. 18/438,702 that are specific to the game, and/or other assets or information.

In various implementations, camera controller 452 may be configured to control a camera for the game. In particular, camera controller 452 may be configured to control the camera based on player inputs. For example, if client-side assets indicate that the game is 1st-person-view, camera controller 452 may be configured to move the camera according to player character (PC) head movements. In various implementations, camera controller 452 may be configured to use another client-side descriptor (which may be included, for example, as a part of the client-side assets) that describes what kind of camera movement is to be used for a particular game (e.g., this may include type of view (1st-person, 3rd-person, fixed camera, etc.), coordinates/offsets for the view, and/or other parameters related to the camera).

In various implementations, 3D rendering engine 470 may be configured to receive game data from subscription 440 for rendering. In some implementations, 3D rendering engine 470 may implement traditional game-related features such as animation 472, visual effects (“VFX”) 474 (such as fire, magic spells, particle effects, and/or other visual effects), post-processing 476, physics simulation 478, a user interface (UI) 482, screen-to-3D translation services 484, and/or other modules or components. In some implementations, 3D rendering engine 470 may use one or more additional client-side descriptor(s) (which may be included, for example, as a part of the client-side assets) to describe a desired VFX 474, post-processing 476, and UI 482. In various implementations, universal game client 400 (and 3D rendering engine 470) may be configured to render a virtual scene for an online game based on game state data, input or data received or maintained by 3D rendering engine 470 (or one or more components of 3D rendering engine), and calculations and/or simulations performed by 3D rendering engine 470 (or one or more components of 3D rendering engine).

In some implementations, 3D rendering engine 470 may be configured to implement animation 472 using traditional animation assets, such as per-frame animation or keyframe-based animation (but still as a part of client-side assets). When implementing movements, in some implementations, 3D rendering engine 470 may be configured to use inverse kinematics to improve the look of the animation. Inverse kinematics comprises a process of obtaining joint angles from known coordinates of an end of a kinematic chain. For example, if hip and foot coordinates for a character are known, inverse kinematics may be used to determine corresponding hip, knee, and ankle angles for the character. In some implementations, to facilitate inverse kinematics, renderer 450 may be configured to generate “collision helpers” to indicate surfaces where inverse kinematics is able to place feet or hands of the character. In such implementations, collision helpers may depend on the 3D rendering engine 470. For example, if Unity is used as 3D rendering engine 470, renderer 450 may be configured to generate Unity colliders such as Box Colliders as “collision helpers.” If the Unreal Engine (UE) is used as 3D rendering engine 470, renderer 450 may be configured to generate invisible static meshes with collision property set. To generate “collision helpers,” renderer 450 may be configured to use information from client-side assets. For example, in some implementations, renderer 450 may be configured to use 3D meshes (e.g., corresponding to buildings and/or other objects) to form the level. In other implementations, renderer 450 may be configured to use pre-processed information provided as a part of client-side assets. For example, the client-side assets may include a pre-processed list of mesh triangles acting as “collision helpers,” (i.e., “pre-collision helpers”).

In various implementations, 3D rendering engine 470 may be configured to provide screen-to-3D translation services 484. In some implementations, UI controller 480 may be configured to use screen-to-3D translation services 484 to show UI elements based on “which 3D object is shown under a specific point on the screen.” For example, UI controller 480 may show UI elements based on “which 3D object is shown under the mouse pointer.” In various implementations, 3D rendering engine 470 may be configured to issue UI player inputs. For example, if a mouse is clicked, UI controller 480 may be configured to issue a UI player input “pick up the 3D object with ID=XXX”, where XXX is known from screen-to-3D translation (or conversion) using screen coordinates of the mouse pointer (i.e., using ID of the “object currently displayed under mouse pointer”).

In various implementations, 3D rendering engine 470 may provide physics simulation 478. In some implementations, physics simulation 478 may include rigid body physics, soft body physics, ragdoll physics, and/or any other physics simulation techniques. In some implementations, physics simulation 478 may be a simulation of only visual effects (i.e., without affecting gameplay or passing any information regarding outcome of simulation outside of 3D rendering engine 470, or at least without passing it back to a game server). In some implementations, physics simulation 478 may use “partial simulation results.” For example, physics simulation 478 may use centers of explosions and/or trajectory of center of mass published by a game server as described in U.S. patent application Ser. No. 18/670,011, to simulate physics such as explosions and/or ragdoll physics. In some implementations, 3D rendering engine 470 may use one or more additional client-side descriptors (which may be included, for example, as a part of the client-side assets) to describe a desired physics simulation 478.

With universal game client 400, all the decisions about gameplay may be made on server-side in a true authoritative game server. For example, in system 100, game server 210 may comprise an authoritative universal game server as described in U.S. patent application Ser. No. 18/670,011. In some implementations, universal game client 400 may be configured to use third-party code (e.g., such as executable code or bytecode) instead of, or in addition to, one or more of client-side descriptors. In some implementations, universal game client 400 may be configured to run third-party code inside of sandboxes (e.g., as described in U.S. patent application Ser. No. 18/670,011).

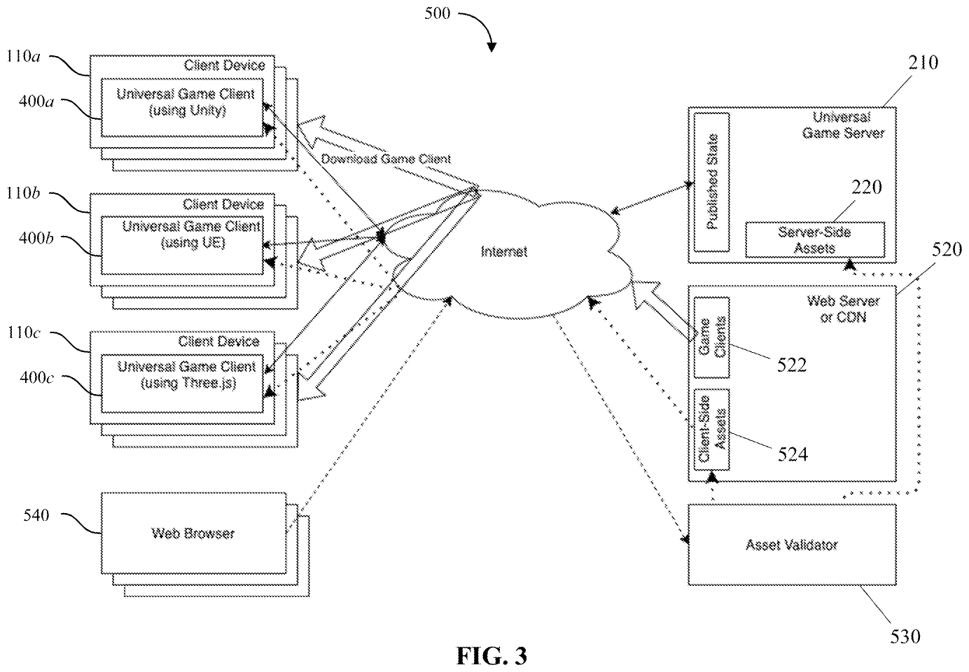

In various implementations, universal game client 400 may be provided for download onto client devices (e.g., on client computer system 110). For example, FIG. 3 depicts a block diagram of an example game streaming architecture 500 in which game clients 400 are provided for download, according to one or more aspects described herein. In various implementations, universal game client may be provided for download over the Internet from a web server or Content Delivery Network (CDN) 520. In various implementations, a web server or CDN 520 may provide both game clients 400 and client-side assets 524 for download. In various implementations, game clients 400a, 400b, 400c may be downloaded and installed onto client devices 110a, 110b, 110c, respectively, via web browsers, ftp clients, app stores, and/or other standard means. In various implementations, different universal game clients 400 may use the same protocol (such as a publication protocol) and may download client-side assets 524, for example, as described in U.S. patent application Ser. No. 18/630,409.

As depicted in FIG. 3, in game streaming architecture 500, different universal game clients 400 may be configured to use different 3D rendering engines 470. For example, different universal game clients 400 may be configured to use various third-party 3D rendering engines 470, such as Unity 400a, Unreal Engine (UE) 400b, three.js 400c, and/or any other suitable game engines. In some implementations, universal game clients 400 may use third-party three-dimensional rendering engines 470 for mere rendering, which in turn may allow the same code to be used for most of universal game client 400 (e.g., excluding renderer 450). In particular, a Unity-based game client 400a (i.e., a game client 400 using a Unity-based rendering engine) or a UE-based game client 400b (i.e., a game client 400 using a UE-based rendering engine) may not include any game-specific logic or any game-specific assets, and may be exactly the same or at least almost the same regardless of the game. Note that it is common for game clients (such as Unity-based game clients or UE-based game clients) to implement gameplay logic based on the same engine (such as Unity or UE) that is used for rendering. With universal game client 400, however, this may be different as a third-party game engine (such as Unity or UE) may be used only for rendering, without any gameplay implemented at or based on that third-party game engine. The term “mere rendering” may be used herein to refer to such uses of third-party game engines. Accordingly, in various implementations, universal game client 400 may be configured to perform calculations and run simulations, as described herein, separate from a third-party game engine (e.g., 3D rendering engine 470).

Notably, such an arrangement may provide advantages from a business perspective, as companies using third-party 3D rendering engines 470 that have a per-seat license (e.g., such as Unity) may need only one license for the entire company, by merely compiling/building the client from universal game client source code, with the rest of the development being done elsewhere, and therefore not subject to per-seat licensing.

In various implementations, web browser 540 may be used by developers (including “modders”) to upload game assets to asset validator 530. As depicted in FIG. 3, in various implementations, asset validator 530 may validate uploaded game assets including both client-side assets 524 and server-side assets 220. In various implementations, client-side assets 524 may be available via a web server and/or CDN 520 such that universal game clients 400 may download client-side assets 524 via the Internet. In various implementations, server-side assets 220 may be available from a universal game server 210.

In some implementations, asset validator 530 may be configured to enforce one or more pre-defined per-object-type restrictions on three-dimensional assets. For example, asset validator 530 may be configured to enforce one or more of the following restrictions: on a number of triangles, a number of materials, a number of pixels in textures, and compressed picture sizes. As used herein, “per-object-type” may mean that different sets of restrictions are set for different object types (e.g., such as one set of restrictions for characters, another set of restrictions for coats, another set of restrictions for pants, another set of restrictions for buildings, and so on). In some implementations, restrictions may vary for different Levels of Detail (LODs). In some implementations, asset validator 530 may be configured to generate LODs from uploaded game assets. In certain implementations, LODs may be generated using one or more techniques, such as traditional decimation methods and/or techniques described in U.S. patent application Ser. No. 18/587,095, entitled “SYSTEMS AND METHODS FOR CREATING LEVELS OF DETAIL USING PERCEPTUAL DEGRADATION,” filed Feb. 26, 2024, the content of which is hereby incorporated by reference herein in its entirety.

In some implementations, restrictions may be generated using techniques described in U.S. patent application Ser. No. 18/587,095. For example, looking at several “typical” assets for each asset type, techniques described in U.S. patent application Ser. No. 18/587,095 may be applied to these assets before taking an average (e.g., such as arithmetic mean, geometric mean, or harmonic mean) over the assets as a restriction for the corresponding type. In other implementations, instead of taking some average, a maximum, a minimum, or a pre-defined percentile may be used over the assets as a restriction for a corresponding type. In some implementations, asset validator 530 may additionally be configured to generate (and/or validate) “pre-collision helpers,” as described herein.

In various implementations, the game streaming architecture 500 depicted and described with respect to FIG. 3 may allow for 3D-based game streaming, where games (broadly) can be uploaded in terms of client-side assets 524 and server-side assets 220 used to run the game. In various implementations, the game streaming architecture 500 may allow various types of games to be generated and run, ranging from slower-paced games (e.g., turn-based games) to fast-paced First-Person Shooters (FPS). Moreover, if techniques described, for example, in U.S. patent application Ser. No. 18/669,729 are used, game streaming architecture 500, coupled with the systems and methods described herein, may be configured to achieve lower latencies than popular existing games, such as Counter-Strike.

In various implementations, universal game client 400 may be configured to protect game assets transmitted and stored within system 100. For example, universal game client 400 may be configured to use one or more techniques for protecting game assets described in U.S. patent application Ser. No. 18/643,569, entitled “SYSTEMS AND METHODS FOR PROTECTING GAME ASSETS FOR ONLINE GAMES” filed Apr. 23, 2024, the content of which is hereby incorporated by reference herein in its entirety. For example, in some implementations, universal game client 400 may be configured to use one or more techniques for protecting game assets when there are license obligations to protect assets and/or to help modders comply with license restrictions when using game assets. In some implementations, this may include universal game client 400 partially decrypting game assets on download, re-encrypting the assets for storage, and selectively (or on-demand) decrypting when loading the assets. In some implementations, universal game client 400 may be configured to avoid having more than a very small chunk of assets in memory in decrypted form. In various implementations, information or assets described as “embedded” in U.S. patent application Ser. No. 18/643,569 may be included (and provided to universal game client 400) as part of an initial game download. In some implementations, universal game client 400 may be configured to avoid downloading interpretable code to a game client (which may be necessary to comply with guidelines of certain app stores, such as the Apple App Store).

In various implementations, universal game client 400 may be configured to facilitate cross-platform gameplay using a specific renderer for different platforms. For example, in some implementations, universal game client 400 may include three.js-based renderer for HTML5/WebGL clients, Unity-based renderer for mobile platforms such as iOS and Android, and UE4-based renderer for desktop platforms such as Windows, MacOS, and Linux, and for consoles such as Xbox, PlayStation, and Nintendo. In some implementations, universal game client 400 may be embedded as a part of a web browser 540. In some implementations, universal game client 400 may be implemented as a browser add-on or plug-in.

In some implementations, universal game client 400 may be configured to send timestamps (generated on the client-side) with each or some of the player inputs sent to the server-side. In some such implementations, these timestamps may be used on the server-side to implement lag compensation and/or server rewind, as described in U.S. patent application Ser. No. 18/670,011.

In some implementations, universal game client 400 may be configured to use information regarding predicted movements of three-dimensional objects (as described in U.S. patent application Ser. No. 18/669,729) to load and/or prioritize LODs of 3D objects. For example, universal game client 400 may be configured to use information regarding predicted movements of three-dimensional objects to load and/or prioritize LODs of 3D objects using one or more techniques described in U.S. patent application Ser. No. 18/630,409.

While various operations are described herein as being performed by the client computer system 110 or the game server 210 (or one or more components of client computer system 110 or game server 210), it is to be understood that, unless explicitly indicated otherwise, each of the one or more operations described herein as being performed by a client computer system 110 could be performed by a game server 210 and that each of the operations described herein as being performed by a game server 210 could be performed by a client computer system 110.

Electronic storage 130 may include electronic storage media that electronically stores and/or transmits information. The electronic storage media of electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). Electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. Electronic storage 130 may be a separate component within system 100, or electronic storage 130 may be provided integrally with one or more other components of system 100 (e.g., client computer system 110, processor(s) 112, game server 210, processor(s) 212, and/or other components). Although electronic storage 130 is shown in FIG. 1 as a single entity, this is for illustrative purposes only. In some implementations, electronic storage 130 may comprise a plurality of storage units. These storage units may be physically located within the same device, or electronic storage 130 may represent storage functionality of a plurality of devices operating in coordination.

Electronic storage 130 may store software algorithms, information determined by processor(s) 112, 212, information received remotely, and/or other information that enables system 100 to function properly. For example, electronic storage 130 may store standard three-dimensional meshes or models, information relating to one or more three-dimensional meshes or models, one or more meshes, one or more textures, one or more normal maps, and/or other information related to the systems and methods described herein.

Game server 210 may comprise a remote server configured to provide publications and game state data related to an online game comprising three-dimensional virtual scenes to client computer system 110. In some implementations, game server 210 may be configured to provide to client computer system 110 publications related to an online game that include cause three-dimensional object(s) to be rendered within a virtual scene. For example, a publication may cause a virtual scene to be constructed comprising at least one object to be generated based on a generic asset, a base texture, and assets received in response to a request. In various implementations, game server 210 may be configured as a server device (e.g., having one or more server blades, processors, etc.) and/or as another device capable of providing publications and game state data related to an online game to client computer system 110.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific example aspects and implementations of the disclosure, and performing certain actions.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of digital processors, analog processors, digital circuits designed to process information, central processing units, graphics processing units, microcontrollers, microprocessors, field programmable gate arrays (FPGAs), application specific transformed circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112, 212 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112, 212 as well as data that may be manipulated by processor(s) 112, 212. The electronic storage may comprise floppy disks, hard disks, optical disks, tapes, or other storage media for storing computer-executable instructions and/or data.

Although illustrated in FIG. 1 as a single component, client computer system 110 and game server 210 may each include a plurality of individual components (e.g., computer devices) each programmed with at least some of the functions described herein. In this manner, some components of client computer system 110 and/or associated client computing device(s) may perform some functions while other components may perform other functions, as would be appreciated. Furthermore, it should be appreciated that although the various instructions are illustrated in FIG. 1 as being co-located within a single processing unit, in implementations in which processor(s) 112, 212 include multiple processing units, one or more instructions may be executed remotely from the other instructions.

One or more components of system 100 may communicate with each other through hard-wired communication, wireless communication, or both. In various implementations, one or more components of system 100 may communicate with each other through a network. For example, client computer system 110 and/or game server 210 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Although client computer system 110, electronic storage 130, and game server 210 are shown to be connected to interface 102 in FIG. 1, any communication medium may be used to facilitate interaction between any components of system 100. For example, as referred to herein, interface 102 may comprise a network via which client computer system 110 may transmit packets or otherwise communicate with game server 210. In some implementations, the connections forming the network represented by interface 102 may include Asymmetric Digital Subscriber Line (ADSL), Symmetric Digital Subscriber Line (SDSL), cable, 3G, 4G, LTE, Ethernet, or any other existing or future developed systems and/or methods of communication with similar functionalities. In some implementations, one or multiple connections may be used to facilitate communication (e.g., transmit packets) between client computer system 110 and game server 210. Indeed, while described herein as a single interface 102 for simplicity, interface 102 may include one or multiple physical and/or virtual interfaces via which packets may be sent from client computer system 110 to game server 210, and vice versa. For example, multiple connections forming a Local Area Network (LAN), Intranet, or Internet may be used to facilitate communication between client computer system 110 and game server 210.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered example only, and the scope of the invention is accordingly intended to be limited only by the following claims.

What is claimed is:

1. A system for three-dimensional model-based game streaming, the system comprising:
a client computer system having one or more processors configured to run a universal game client capable of running various types of three-dimensional games,
wherein the universal game client is configured to receive game state data published by a game server,
wherein the universal game client is configured to render a virtual scene for an online game based on the game state data.

2. The system of claim 1, the system further comprising the game server, wherein the game server is configured to simulate the online game and publish the game state data, wherein the game state data is based on the simulation of the online game at the game server.

3. The system of claim 1, wherein the universal game client and one or more game assets associated with a game are provided for download over the Internet, wherein the one or more processors are configured to download at least the universal game client.

4. The system of claim 1, wherein the universal game client is configured to render the virtual scene for the online game based further on client-side game assets.

5. The system of claim 4, wherein the client-side game assets are downloaded as a part of an initial game download for the online game.

6. The system of claim 4, wherein the client-side game assets include one or more client-side descriptors that each provide information related to the online game.

7. The system of claim 1, wherein the game state data includes coordinate data and velocity data for at least one object at a first time, wherein the at least one object is rendered within the virtual scene by the universal game client based on the game state data.

8. The system of claim 7, wherein the universal game client is configured to receive updated game state data published by the game server, and wherein the universal game client is configured to update a rendering of the at least one object based on the updated game state data.

9. The system of claim 7, wherein the universal game client is configured to calculate coordinates and a velocity for the object after the first time based at least on the coordinate data for the object at the first time and the velocity data for the object at the first time, wherein the universal game client is configured to render the at least one object based on the calculated coordinates and velocity for the object after the first time.

10. The system of claim 9, wherein the universal game client is configured to render the at least one object based on the calculated coordinates and velocity for the object after the first time without receiving updated game state data related to the at least one object after the game state data including the coordinate data and the velocity data for the at least one object at the first time.

11. The system of claim 10, wherein the universal game client is configured to calculate the coordinates and velocity for the object after the first time based further on one or more velocity profiles associated with the object.

12. The system of claim 11, wherein the one or more velocity profiles are embedded within universal game client.

13. The system of claim 1, wherein the universal game client is configured to run a physics simulation related to an object and render the object within the virtual scene based on an outcome of the physics simulation run on the universal game client.

14. The system of claim 13, wherein the physics simulation is used only for visual effects and the outcome of the physics simulation is not passed back to the game server.

15. The system of claim 13, wherein the object is rendered within the virtual scene based further on partial simulation results obtained by the universal game client from the game server.

16. The system of claim 1, wherein the universal game client includes a third-party three-dimensional rendering engine configured to render the virtual scene for the online game.

17. The system of claim 16, wherein the universal game client is configured to implement gameplay logic to perform calculations and run simulations separate from the third-party three-dimensional rendering engine.

18. The system of claim 1, wherein universal game client is configured to utilize inverse kinematics to render movement of an object within the virtual scene for the online game.

19. The system of claim 1, wherein the universal game client is embedded as a part of a web browser.

20. The system of claim 1, wherein the universal game client includes at least one server proxy, wherein the server proxy is configured to receive a first subscription comprising the game state data published by the game server, and generate a second subscription used by the universal game client to render the virtual scene.

21. The system of claim 20, wherein the server proxy is configured to predict movement of an object based on the game state data, wherein the second subscription includes game state data updated based on the predicted movement of the object.

22. The system of claim 21, wherein the universal game client is configured to receive player input, and wherein the server proxy is configured to predict the movement of the object based further on the received player input.

23. The system of claim 1, wherein game state data published by the game server includes two-dimensional representations of game data, wherein the universal game client includes a translator configured to translate the two-dimensional representations of the game data into three-dimensional representations of the game data.

24. The system of claim 23, wherein the translator is configured to translate the two-dimensional representations of the game data into the three-dimensional representations of the game data based on a graph of two-dimensional polygons.

25. The system of claim 1, wherein game state data published by the game server includes one-dimensional representations of game data, wherein the universal game client includes a translator configured to translate the one-dimensional representations of the game data into three-dimensional representations of the game data.
